(19) United States
(12) Patent Application Publication
(10) Pub. No.: US 2026/0361216 A1
(43) Pub. Date: Nov. 12, 2026

(54) VARIABLE OFF-TIME CONVERTER AND CONVERSION WITH VARIABLE RAMP SLOPE IN FEEDBACK LOOP

(71) Applicant: Infineon Technologies Canada Inc., Ottawa (CA)

(72) Inventors: Samiran DAM, Bangalore (IN); Ramesh Karpur GOPINATHAN, Bangalore (IN); Ashutosh Ravindra JOHARAPURKAR, Bangalore (IN)

(21) Appl. No.: 19/205,582

(22) Filed: May 12, 2025

(51) Int. Cl. H02M 3/156

(52) U.S. Cl. CPC H02M 3/156

(57) ABSTRACT

A constant on-time voltage-to-voltage converter comprising an alternation circuit and a variable off-time feedback loop. The alternation circuit alternates control of the converter between a constant on-time phase and a variable off-time phase. By using the alternation circuit to control how long the off-time phase lasts compared to the on-time phase, a specific output voltage on an output terminal of the converter may be achieved. The feedback loop includes a ramp circuit and a comparator. The ramp circuit generates a ramp voltage having a slope that is based on the output voltage. The comparator outputs an off-time signal based on the rate of change of the ramp voltage to the alternation circuit. The alternation circuit is capable of controlling the off-time phase based on the output voltage, allowing the converter to be used for a range of output voltages, without the need for specialized programmable circuit components.

### BACKGROUND

Voltage-to-voltage converters are used to safely convert one voltage to another voltage required by a load device. For example, AC/DC converters are commonly used in residential applications to convert 110-120 volts (AC) from a standard residential power outlet to approximately 6-12 volts (DC) for use in charging electronic devices. However, different load devices may require different input DC voltages, and so DC/DC converters may be used to convert one level of DC voltage to another. For example, DC/DC converters are frequently used in power supplies for electronic devices (e.g., laptops, smartphones, tablets, etc.), automotive devices, solar power systems, industrial control systems, and telecommunications networks.

There are various types of DC/DC converters, including buck converters (also known as “step-down converters”), boost converters (also known as “step-up converters”), buck-boost converters (also known as “voltage inverters”), and isolated DC/DC converters. Most DC/DC converters include a variety of passive components such as diodes, inductors, capacitors, and in some cases transformers. However, many DC/DC converters also include active components, such as switches (e.g., implemented using transistors), which may be opened and closed at a given rate to achieve a specific output DC voltage based on an input DC voltage.

The subject matter claimed herein is not limited to embodiments that solve any disadvantages or that operate only in environments such as those described above. Rather, this background is only provided to illustrate one example technology area where some embodiments described herein may be practiced.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Embodiments described herein relate to constant on-time voltage-to-voltage converters for converting an input voltage to an output voltage. The converter is highly stable across a wide range of output voltages by using a ramp circuit that generates a ramp voltage having a slope that depends on the output voltage of the conversion. Although the principles described herein relate to the ramp circuit, the remainder of the constant on-time voltage-to-voltage converter will also be described.

A constant on-time voltage-to-voltage converter includes an alternation circuit that generates an output voltage by alternating control of the constant on-time voltage-to-voltage converter between a constant on-time phase and a variable off-time phase. During the constant on-time phase, the alternation circuit causes an output terminal of the constant on-time voltage-to-voltage converter to be coupled to a first input terminal. This coupling may be achieved via an inductor such that the coupling causes the voltage at the output terminal to trend towards the first voltage at the first input terminal that has a first voltage. On the other hand, during the variable off-time phase, the alternation circuit causes the output terminal to instead be coupled to a second input terminal that has a second voltage. This coupling may also be achieved via the inductor such that the coupling causes the voltage at the output terminal to trend towards the second voltage at the second input terminal. As an example only, the second voltage is ground, and the first voltage is an externally-applied voltage.

By using the alternation circuit to control how long the variable off-time phase lasts compared to the constant on-time phase, and by having the switching occur relatively quickly, a specific output voltage on the output terminal may be achieved. For example, in the case where the second voltage is ground and the first voltage is 6 volts, a longer off-time phase compared to the on-time phase may allow for a lower output voltage (e.g., positive 0.6 volts) to be achieved. On the other hand, a shorter off-time phase compared to the on-time phase may allow for a higher output voltage (e.g., positive 5.5 volts) to be achieved. Accordingly, a specific output voltage in a range of output voltages may be achieved by using the alternation circuit to control how long the variable off-time phase lasts.

To allow the alternation circuit to adjust the amount of time for the variable off-time phase to achieve a specific output voltage, the constant on-time voltage-to-voltage converter further includes a variable off-time feedback loop coupled between the output terminal and the alternation circuit. To achieve stability across a wide range of output voltages, the variable off-time feedback loop includes a ramp circuit and a comparator, with the ramp circuit generating a ramp voltage that has a slope that depends on the output voltage on the output terminal. The comparator receives the ramp voltage from the ramp circuit, and generates an off-time signal with a timing that depends on the rate of change of the ramp voltage generated by the ramp circuit. A steeper slope of the ramp voltage will cause the off-time signal to be generated more quickly for a shorter off-time phase. On the other hand, a shallower slope of the ramp voltage will cause the off-time signal to be generated more slowly for a longer off-time phase. The alternation circuit receives the off-time signal from the comparator, such that the alternation circuit controls the variable off-time phase based on the off-time signal from the comparator.

Accordingly, the alternation circuit is capable of dynamically controlling the duration of the variable off-time phase based on the output voltage on the output terminal. Because the ramp voltage has a slope that may change depending on the output voltage of the conversion, the conversion is stable across a wide range of output voltages. For example, if the input voltage is 6 volts, the output voltage may be selected to be anywhere from perhaps 0.6 volts to 5.5 volts by varying the slope of the ramp voltage. Thus, the converter having adjustable slope in the ramp voltage allows for the constant on-time voltage-to-voltage converter to be used for a wide range of output voltages without the need for specialized programmable circuit components.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the advantages and features of the embodiments described herein can be obtained, a more particular description will be rendered by reference to specific embodiments thereof which are illustrated in the appended drawings. Understanding that these drawings depict only typical embodiments described herein, and are not therefore to be considered to be limiting of the scope of the inventive principles, the embodiments will be described and explained with additional specificity and detail through the use of the accompanying drawings in which:

FIG. 1 illustrates a constant on-time voltage-to-voltage converter for converting an input voltage to an output voltage, in accordance with the principles described herein;

FIG. 2 illustrates a simple time-wise state diagram of various cycles of alternation between a constant on-time phase, and a variable off-time phase;

FIG. 3 illustrates a constant on-time voltage-to-voltage converter that represents an example of the constant on-time voltage to voltage converter of FIG. 1, and in which the alternation circuit is composed of a logic circuit and a buck converter with the logic circuit controlling the buck converter;

FIG. 4 illustrates a variable off-time feedback loop that represents an example of the variable off-time feedback loop of FIG. 3;

FIG. 5 illustrates a ramp circuit that represents an example of the ramp circuit of FIG. 4, which can operate in both Continuous Conduction Mode (CCM) and Discontinuous Conduction Mode (DCM) whilst controlling the ramp voltage;

FIG. 6 illustrates several state and signal diagrams in which time is represented by horizontal positioning, and in which the ramp voltage is generated to achieve CCM mode; and

FIG. 7 illustrates several state and signal diagrams in which time is represented by horizontal positioning, and in which the ramp voltage is generated to achieve DCM mode.

### DETAILED DESCRIPTION

Voltage-to-voltage converters may control their output voltage by controlling how long the on-time phase lasts compared to the off-time phase per cycle, where each cycle is the same length. Thus, to have a higher output voltage, the on-time phase would last longer compared to the off-time phase (i.e., the duty cycle could be increased). On the other hand, to have a lower output voltage, the on-time phase would last shorter compared to the off-time phase (i.e., the duty cycle is decreased). However, the constant on-time voltage-to-voltage converter controls its output voltage by lengthening or shortening the off-time phase between each on-time phase, where each on-time phase lasts the same length of time, hence the term “constant on-time voltage-to-voltage converter”. Accordingly, given a constant duration for each on-time phase, a constant on-time voltage-to-voltage converter controls the output voltage by controlling the duration of the off-time phase that is between each on-time phase.

In accordance with the principles described herein, the converter is highly stable across a wide range of output voltages by using a ramp circuit that generates a ramp voltage having a slope that depends on the output voltage of the conversion. A constant on-time voltage-to-voltage converter includes an alternation circuit that generates an output voltage by alternating control of the constant on-time voltage-to-voltage converter between a constant on-time phase and a variable off-time phase. During the constant on-time phase, the alternation circuit causes an output terminal of the constant on-time voltage-to-voltage converter to be coupled to a first input terminal. This coupling may be achieved via an inductor such that the coupling causes the voltage at the output terminal to trend towards the first voltage at the first input terminal that has a first voltage. On the other hand, during the variable off-time phase, the alternation circuit causes the output terminal to instead be coupled to a second input terminal that has a second voltage. This coupling may also be achieved via the inductor such that the coupling causes the voltage at the output terminal to trend towards the second voltage at the second input terminal. As an example only, the second voltage is ground, and the first voltage is an externally-applied voltage.

By using the alternation circuit to control how long the variable off-time phase lasts compared to the constant on-time phase, and by having the switching occur relatively quickly, a specific output voltage on the output terminal may be achieved. For example, in the case where the second voltage is ground and the first voltage is 6 volts, a longer off-time phase compared to the on-time phase may allow for a lower output voltage (e.g., positive 0.6 volts) to be achieved. On the other hand, a shorter off-time phase compared to the on-time phase may allow for a higher output voltage (e.g., positive 5.5 volts) to be achieved. Accordingly, a specific output voltage in a range of output voltages may be achieved by using the alternation circuit to control how long the variable off-time phase lasts.

To allow the alternation circuit to adjust the amount of time for the variable off-time phase to achieve a specific output voltage, the constant on-time voltage-to-voltage converter further includes a variable off-time feedback loop coupled between the output terminal and the alternation circuit. To achieve stability across a wide range of output voltages, the variable off-time feedback loop includes a ramp circuit and a comparator, with the ramp circuit generating a ramp voltage that has a slope that depends on the output voltage on the output terminal. The comparator receives the ramp voltage from the ramp circuit, and generates an off-time signal with a timing that depends on the rate of change of the ramp voltage generated by the ramp circuit. A steeper slope of the ramp voltage will cause the off-time signal to be generated more quickly for a shorter off-time phase. On the other hand, a shallower slope of the ramp voltage will cause the off-time signal to be generated more slowly for a longer off-time phase. The alternation circuit receives the off-time signal from the comparator, such that the alternation circuit controls the variable off-time phase based on the off-time signal from the comparator.

Accordingly, the alternation circuit is capable of dynamically controlling the duration of the variable off-time phase based on the output voltage on the output terminal. Because the slope of the ramp voltage may change depending on the output voltage of the conversion, the conversion is stable across a wide range of output voltages. For example, if the input voltage is 6 volts, the output voltage may be selected to be anywhere from perhaps 0.6 volts to 5.5 volts by varying the slope of the ramp voltage. Thus, the converter having adjustable slope in the ramp voltage allows for the constant on-time voltage-to-voltage converter to be used for a wide range of output voltages without the need for specialized programmable circuit components.

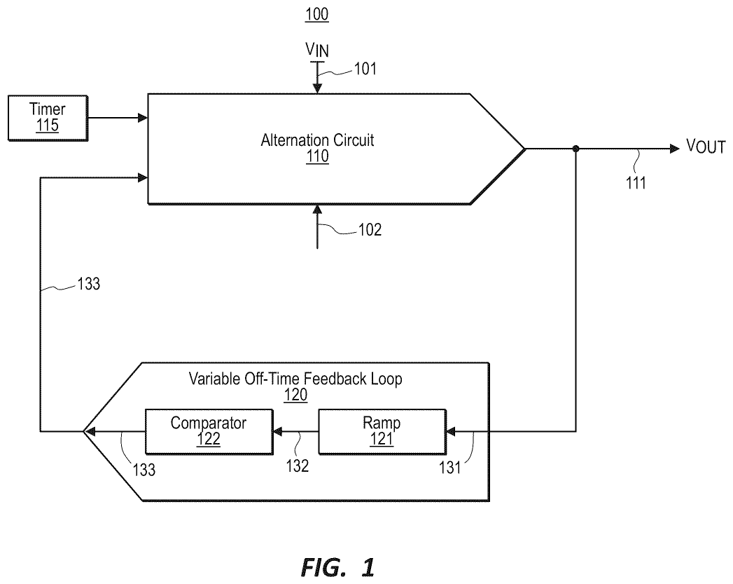

FIG. 1 illustrates a constant on-time voltage-to-voltage converter 100 for converting an input voltage VIN to an output voltage VOUT, in accordance with the principles described herein. The constant on-time voltage-to-voltage converter 100 includes an alternation circuit 110 and a variable off-time feedback loop 120. The alternation circuit 110 causes the constant on-time voltage-to-voltage converter 100 to alternate between a constant on-time phase and a variable off-time phase. The “on-time phase” will also be referred to herein as simply the “on phase”, and the “off-time phase” will also be referred to herein as simply the “off phase”.

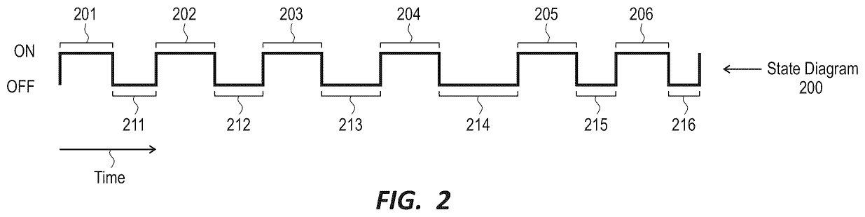

FIG. 2 illustrates a simple time-wise state diagram 200 of various cycles of alternation between an on phase, and an off phase. The on phase is shown as a high state in the state diagram 200, and includes in this example on phases 201 through 206. For a given input voltage VIN and a given output voltage VOUT, the on phase has a constant duration in each cycle. Accordingly, each of the on phases 201 through 206 has the same width in the time-wise state diagram 200.

On the other hand, the off time is shown as a low state in the state diagram 200, and includes in this example off phases 211 through 216. Since the off phase has a variable duration from one cycle to the next, each of the off phases 211 through 216 is not necessarily of the same duration and in fact is almost certainly variable in duration from one cycle to the next. This is represented by each of the durations of the off phases 211 through 216 not being constrained to a fixed duration. This is true even given a constant input voltage VIN and a constant output voltage VOUT. For instance, the duration of the duty cycle may vary to maintain the output voltage VOUT if the load conditions change, or if perhaps there is some fluctuation in environmental conditions experienced by the constant on-time voltage-to-voltage converter 100.

The duration of the off phases in FIG. 2 is not a real example, and the variability in duration is exaggerated simply to make the point that there is variability in duration of each successive off phase. In a relatively stable constant on-time voltage-to-voltage converter 100, the duration of each successive off phase will likely be more subtly changed from one cycle to the next so as to achieve a stable output voltage VOUT in response to subtly changing conditions. That is, from one cycle to the next, small changes in the output voltage VOUT present on the output terminal 111 will cause small adjustments to the duration of the off phase.

Returning to FIG. 1 and with references to the example time-wise state diagram 200 of FIG. 2, during the constant on-time phase, the alternation circuit 110 causes an output terminal 111 of the constant on-time phase voltage-to-voltage converter 100 to be coupled to a first input terminal 101 on which a first voltage is externally applied. This first voltage is actually the input voltage VIN. For instance, during each of the on phases 201 through 206, the alternation circuit 110 causes the output terminal 111 (carrying the output voltage VOUT) to be coupled to the first input terminal 101. As an example, the alternation circuit 110 may cause the on-time phase to be of constant duration in response to a signal from a timer 115. That timer 115 may start timing when the on-phase begins and signal the alternation circuit 110 when the constant time has elapsed, causing the alternation circuit 110 to switch to the variable off-time phase. During the variable off-time phase, the alternation circuit 110 causes the output terminal 111 to instead be coupled to a second input terminal 102 on which a second voltage is applied. For instance, during each of the off phases 211 through 216, the alternation circuit 100 causes the output terminal 111 to be coupled to the second input terminal 102. The duration of any given off-time phase is determined by the variable off-time feedback loop 120.

In one embodiment, the first voltage and the second voltage are relatively fixed. For example, the first voltage (i.e., the input voltage VIN) may be 6 volts, and the second voltage may be ground. In that case, the first input terminal 101 may be considered a first voltage source, and the second input terminal 102 may be considered a second voltage source. However, the principles described herein are applicable even if there is some variability in the first voltage provided on the first input terminal 101, and the second voltage provided on the second input terminal 102.

The term “coupled” may be used herein to describe circuit elements being connected together either directly or via intervening circuit elements. Nonetheless, regardless of any intervening circuitry, when the output terminal 111 is coupled to the first input terminal 101, the voltage at the output terminal 111 tends towards the first voltage at the first input terminal 101, and when the output terminal 111 is coupled to the second input terminal 102, the voltage at the output terminal 111 tends towards the second voltage at the second input terminal 102. If the frequency of alternation between the coupling to the first input terminal 101 and the second input terminal 102 is high enough, the voltage at the output terminal 111 can be relatively stable. In one example that will be used throughout, the first voltage is higher than the second voltage. For instance, the first voltage may be a positive voltage (such as 6 volts), and the second voltage may be ground. In any case, by controlling the duration of the variable off-time phase, the output voltage on the output terminal 111 may be controlled to be at a designated voltage between the first input voltage and the second input voltage.

The alternation circuit 110 is used to control the duration of the variable off-time phase compared to the constant duration of the constant on-time phase, thus allowing a specific output voltage on the output terminal 111 to be achieved given then-existing load and environmental conditions. For example, a shorter off-time phase compared to the on-time phase may allow for a higher output voltage to be achieved which is closer to the first voltage provided at the first input terminal 101. On the other hand, a longer off-time phase compared to the on-time phase may allow for an output voltage to be achieved that is closer to the second voltage provided at the second input terminal 102. Thus, in an example in which the first voltage is 6 volts and the second voltage is ground, the alternation circuit 110 may generate an output voltage between ground and 6 volts.

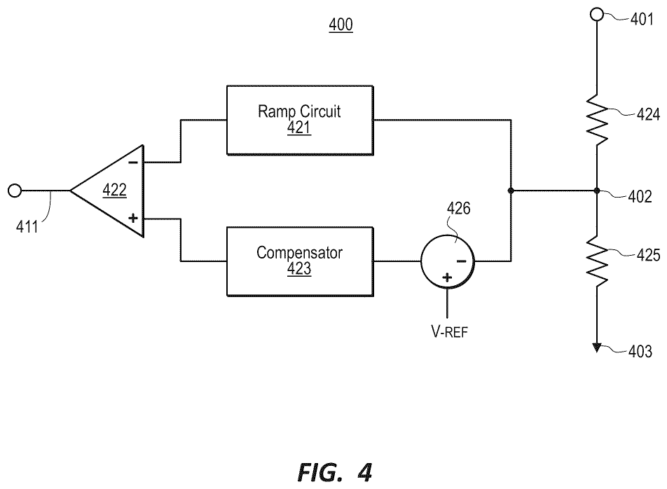

To allow the alternation circuit 110 to adjust the duration of the variable off-time to be the appropriate duration to achieve a specific output voltage given then-existing load and environmental conditions, the variable off-time feedback loop 120 is connected between the output terminal 111 and the alternation circuit 110. The variable off-time feedback loop 120 includes a ramp circuit 121 and a comparator 122. A detailed example circuit structure of the ramp circuit 121 will be described later with respect to FIG. 4. However, for purposes of explanation and context, the basic functionality of the ramp circuit 121 will be described here with respect to FIG. 1.

The ramp circuit 121 generates a ramp voltage that has a slope that depends on the output voltage at the output terminal 111. Thus, as represented by arrow 131, the ramp circuit 121 receives as input the voltage at the output terminal 111. As represented by arrow 132, the ramp circuit 121 generates a corresponding ramp voltage. Specifically, the ramp voltage ramps up or down at a certain rate of change in voltage that depends on the output voltage at the output terminal 111. As also represented by the arrow 132, the comparator 122 receives the ramp voltage from the ramp circuit 121. As represented by arrow 133, the comparator 122 generates an off-time signal that depends on the rate of change of the ramp voltage from the ramp circuit 121.

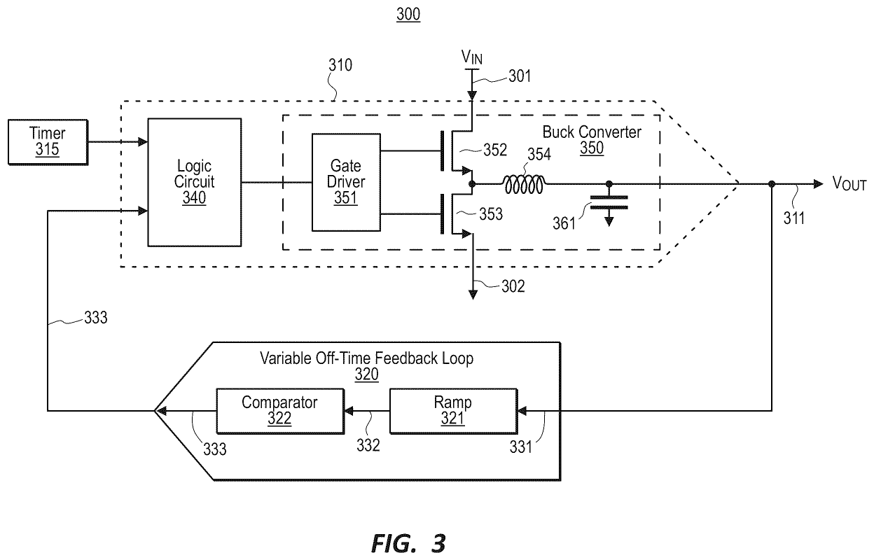

As also represented by the arrow 133, the alternation circuit 110 receives the off-time signal from the comparator 122, such that the alternation circuit 110 controls the duration of the variable off-time phase based on the off-time signal from the comparator 122. The off-time signal causes the alternation circuit 110 to transition to the on phase and also start the timer 115. The steeper the slope of the ramp voltage, the faster the ramp voltage reaches a particular threshold voltage that is also present at the comparator, and thus the faster the comparator generates an off-time signal. Accordingly, with the aid of the variable off-time feedback loop 120, the alternation circuit 110 is capable of dynamically controlling the length of the variable off-time phase based on the output voltage on the output terminal 111 by controlling the slope of the ramp signal. This allows the constant on-time voltage-to-voltage converter 100 to be used for a wide range of output voltages without the need for specialized programmable circuit components. A more detailed example of the constant on-time voltage-to-voltage converter 100 of FIG. 1 will now be described with respect to FIG. 3.

FIG. 3 illustrates a constant on-time voltage-to-voltage converter 300 that represents an example of the constant on-time voltage to voltage converter 100 of FIG. 1. The first input terminal 301 carrying the input voltage VIN, the second input terminal 302 (e.g., being ground), the output terminal 311 (carrying the output voltage VOUT), the timer 315, the variable off-time feedback loop 320, the ramp circuit 321, the comparator 322 and the arrows 331, 332 and 333 of FIG. 3 may be the same as is described for the respective elements 101, 102, 111, 115, 120, 121, 122, 131, 132 and 133 of FIG. 1. However, the alternation circuit 310, which is a mere example of the alternation circuit 110 of FIG. 1, is shown as further including a control circuit 340 and a buck converter 350.

The control circuit 340 controls the buck converter 350 by selectively causing the output terminal 311 to be coupled to the first input terminal 301 or the second input terminal 302. However, the principles described herein are not limited to the control circuit 340 causing couplings via the buck converter 320. In some embodiments, the control circuit may cause the output terminal 311 to be coupled to the input terminals 301 and 302 via any other form of voltage converter circuit, such as a boost converter, a buck-boost converter, an isolated DC/DC converter, or the like.

In the illustrated case, the control circuit 340 controls the buck converter 350 by controlling a gate driver 351. The gate driver 351 in turn controls the on-off state of the transistors 352 and 353 which are connected in series between the first input terminal 301 and the second input terminal 302. While the principles described herein are not limited to the transistors 352 and 353 being any one particular type of transistor, suppose for purposes of explanation only that each of the transistors 352 and 353 are field-effect transistors. The connection between the transistors 352 and 353 is connected through an inductor 354 to the output terminal 311 of the buck converter 350 and of the alteration circuit 320. A capacitor 361 is also connected to the output terminal 311 to encourage voltage stability in the output voltage VOUT.

An on phase is begun when the variable-off time feedback loop 320 sends an off-time signal (indicative of the end of the off-phase) to the logic circuit 340 over connection 333. The logic circuit 340 responds by signaling the gate driver circuit 351 to turn the transistor 352 on, and to turn the transistor 353 off, which represents an on-time state of the buck converter 350. This couples the output terminal 311 to the first input voltage via the channel of the transistor 352 and via the inductor 354, which causes the voltage at the output terminal to trend higher for the duration of the on phase. Additionally, when the on phase begins, the timer 315 begins timing the on phase. The logic circuit 340 itself may trigger the timer 315 to begin timing, or the timer 315 may also be connected to the output 333 of the variable off-time feedback circuit 320 to begin timing in response to the same signal that causes the logic circuit to trigger the transistor 352 on and the transistor 353 off.

An off phase is begun when the timer 315 reaches the duration of the fixed on-time of the on phase, which triggers a signal to the logic circuit 340. The logic circuit 340 responds to this signal by triggering the gate driver 351 to turn the transistor 352 off and the transistor 353 on, which represents an off-time state of the buck converter 350. This couples the output terminal 311 to the second input voltage via the channel of transistor 353 and the inductor 354, which causes the voltage at the output terminal to trend lower for the duration of the on phase. The alternation circuit 310 stays in this state until the variable off-time feedback circuit 320 once again signals the logic circuit 340 via the connection 333.

The cycling is fast enough that the voltage at the output terminal 311 of the constant on-time voltage-to-voltage converter 300 is relatively stable at a desired voltage, provided that the variable off-time feedback circuit 320 provides a correct duration of the off time.

FIG. 4 illustrates variable off-time feedback loop 400 that represents an example of the variable off-time feedback loop 320 of FIG. 3. The variable off-time feedback loop 400 includes a ramp circuit 421 and a comparator 422, which are respective examples of the ramp circuit 321 and the comparator 322 of FIG. 3. However, the variable off-time feedback loop 400 further includes a compensator 423, and two resistors 424 and 425.

The resistor 424 is connected between a first node 401 and a feedback voltage node 402. The first node 401 may be, for example, the output terminal 311 of the constant on-time voltage-to-voltage converter 300 of FIG. 3. Furthermore, the resistor 425 is connected between the feedback voltage node 402 and a voltage source 403 (e.g., ground). As an example only, this voltage source 403 may may provide the same voltage as the second voltage provided at the second input terminal 302 of the alternation circuit 310. The resistors 424 and 425 together act as a voltage divider that generates a feedback voltage on the feedback voltage node 402. The feedback voltage generated on the feedback voltage node 402 depends on the output voltage on the output terminal 311 of the constant on-time voltage-to-voltage converter 300. Specifically, the feedback voltage generated on the feedback voltage node 402 follows the output voltage on the output terminal 311 in voltage-divided form. While resistors are used to show the generation of a voltage-divided voltage at the feedback voltage node, any forms of voltage divider may alternatively be used.

The ramp circuit 421 take the feedback voltage at the feedback node 402 as an input. On the other hand, the compensator 423 receives the feedback voltage at the feedback node 402 after having some reference voltage VREF added to the feedback voltage by the voltage adder 426. This reference voltage VREF is proportional to the output voltage VOUT of the constant on-time voltage-to-voltage converter 300. For instance, the reference voltage VREF may be proportional to the output voltage VOUT times the transfer function of the voltage divider represented by the series combination of the resistor 424 and 425.

The ramp circuit 421 is coupled between the feedback voltage node 412 and a first input node of the comparator 422. The compensator 423 is coupled between the feedback voltage node 402 and a second input node of the comparator 422. The comparator 422 has an output node 411. That output node 411 is connected (via the connection 333) to the logic circuit 340. In FIG. 4, the first input node of the comparator 422 is illustrated as being a negative input node, and the second input node is illustrated as being a positive input node, but it could be vice versa.

The ramp circuit 421 generates a ramp voltage that depends on the feedback voltage on the feedback voltage node 402, and thus that that depends on the output voltage on the output terminal 311 of the constant on-time voltage-to-voltage converter 300. Similarly, the compensator 423 generates a compensated voltage that depends on the feedback voltage on the feedback voltage node 402, and thus that also depends on the output voltage on the output terminal 311 of the constant on-time voltage-to-voltage converter 300, and that depends on the reference voltage VREF. Accordingly, the comparator 232 receives the ramp voltage on the first input node and the compensated voltage on the second input node.

With the illustrated circuit, the DC gain of the converter is given by the following Equation.

$$K = \frac{{V}_{REF} * {F}_{S}}{\frac{{d V}_{RAMP}}{dt}}$$

In this equation, K is the DC gain, VREF is the voltage fed to the voltage adder 426 (which is proportional to the output voltage VOUT as mentioned above), Fs is the switching frequency, and

$$\frac{{d V}_{RAMP}}{dt}$$

is the rate of change of the ramp voltage output by the ramp circuit 421. For a given target bandwidth of DC gain which has K as the central DC gain, and given a fixed switching frequence Fs, stability may be achieved at any target bandwidth by scaling

$$\frac{{d V}_{RAMP}}{dt}$$

with the product of VREF and the switching frequency Fs.

Due to the variable off-time feedback loop 400, the logic circuit 340 is capable of dynamically controlling the duration the variable off-time phase based on the output voltage on the output terminal 311. This allows the constant on-time voltage-to-voltage converter 200 to be used for a wide variety of output voltages without the need for specialized programmable circuit components. Additionally, by regulating the ramp pedestal (where the ramp voltage saturates and stays fixed), the converter may work for both Continuous Conduction Mode (CCM) which has Pulse Width Modulation (PWM), Discontinuous Conduction Mode (DCM) which has Pulse Frequency Modulation (PFM) control modes of operation.

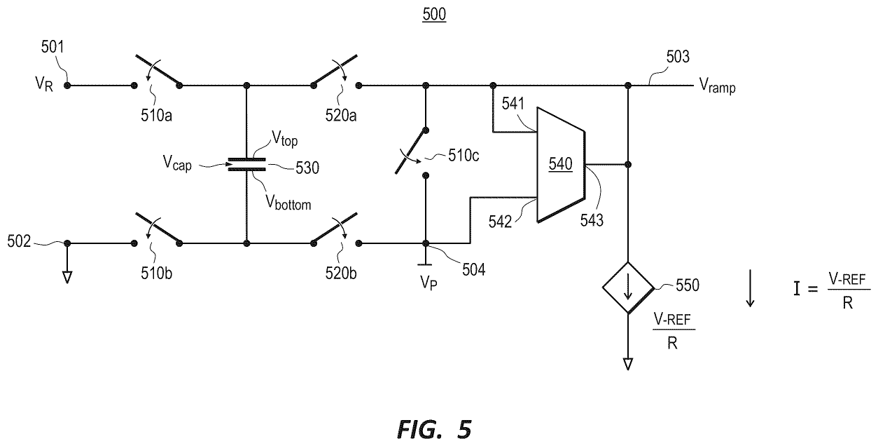

FIG. 5 illustrates a ramp circuit 500 that represents an example of the ramp circuit 421 of FIG. 4, which particularly helps with the aforementioned benefits and which can operate in both CCM and DCM modes whilst controlling the ramp voltage. Again, by controlling the ramp voltage, the DC gain K can be stabilized for a given input voltage and a given output voltage without having to program the compensator. FIG. 5 illustrates a ramp circuit 500, which is an example of the ramp circuit 421 of FIG. 4, the ramp circuit 321 of FIG. 3, and the ramp circuit 121 of FIG. 1. The ramp circuit 500 includes various switches 510a, 510b, 510c, 520a and 520b, as well as a capacitor 530, an amplifier 540 and a current source 550, that together operate in order to control the rate of change of the ramp voltage during the off phase of the constant on-time voltage-to-voltage converter 300.

The switch 510a is connected between a ramp amplitude voltage terminal 501 and an upper terminal of the ramp capacitor 530. As an example only, a ramp amplitude voltage present on the ramp amplitude voltage terminal 501 may be approximately equal to the feedback voltage present on the feedback voltage node 402 of FIG. 4. The switch 510b is connected between a low voltage source 502 and a lower terminal of the ramp capacitor 530. As an example only, the low voltage source 502 may be the same as the low voltage source 403 of FIG. 4 (e.g., providing ground).

The switch 510c is connected between a ramp output terminal 503 and a ramp pedestal terminal 504. The ramp output terminal 503 functions as an output node of the ramp circuit 500 on which the ramp voltage is generated, and may be connected to, for example, the first input node of the comparator 422 of FIG. 4. The ramp pedestal terminal 504 may be provided with a ramp pedestal voltage that is approximately equal to the feedback voltage on the feedback node 402 of FIG. 4, plus some common mode voltage.

The switch 520a is connected between the upper terminal of the ramp capacitor 330 and the ramp output terminal 503. The switch 520b is connected between the lower terminal of the ramp capacitor 530 and the ramp pedestal voltage terminal 504. The amplifier 540 has a first input node 541 connected to the ramp output terminal 503, a second input node 542 connected to the ramp pedestal terminal 504, and an output node 543 also connected to the ramp output terminal 503. In this configuration, the amplifier 540 prevents the ramp voltage on the ramp output terminal 503 from dropping below the ramp pedestal voltage on the ramp pedestal terminal 304.

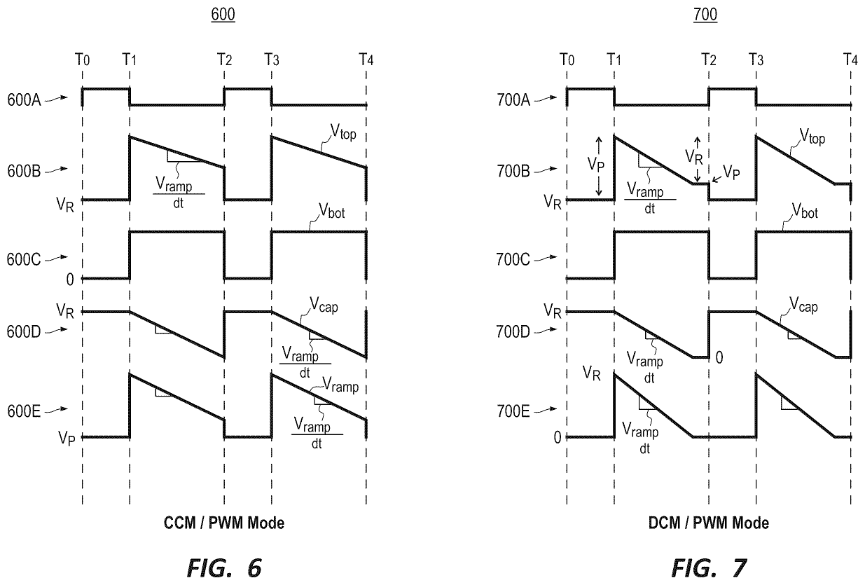

The operation of the ramp circuit 500 to achieve the CCM mode while controlling the ramp voltage slope will be described with respect to FIG. 6. FIG. 6 shows several states and signals in which time is represented by horizontal positioning. State diagram 600A illustrates whether the converter is in the on phase (represented by the high state) or in the off-phase (represented by the low state). An on phase begins at time T0 and ends at time T1. An off phase begins at time T1 and ends at time T2. Another on phase begins at time T2 and ends at time T3. Another off phase begins at time T3 and ends at time T4.

The voltage signal 600B shows the voltage Vtop over time at the top of the capacitor 530. The voltage signal 600C shows the voltage Vbot over time at the bottom of the capacitor 530. The voltage signal 600D shows the voltage Vcap of time across the capacitor 530 (which is just the difference between Vtop and Vbot). The voltage signal 600E shows the ramp voltage Vramp over time output by the ramp circuit 500 of FIG. 5. The description will now describe the CCM mode operation of the ramp circuit 500 walking through the state and signal diagrams of FIG. 6 from time T0 through time T4.

At time T0, an on phase begins as apparent from state diagram 600A. In response, switches 510a, 510b and 510c are closed, and switches 520a and 520b are open. Referring to FIG. 6, the on phase is represented in FIG. 6, by the state diagram 600A being high between times T0 and T1. Because switch 510a is closed, the voltage diagram 600B shows that the voltage at the top of the capacitor 330 (i.e., Vtop) is equal to the input voltage VR to the ramp circuit 500. Again, this input voltage to the ramp circuit is the feedback voltage present between the resistors 424 and 425. Furthermore, because the switch 510b is closed, the voltage diagram 600C shows that the voltage at the bottom of the capacitor 330 (i.e., Vbot) is grounded at zero volts. This means that the voltage across the capacitor is equal to VR between times T0 and T1 as represented in the voltage diagram 600D. Lastly, because the switch 510C is closed, the voltage Vramp is set to the pedestal voltage Vp between times T0 and T1 as represented by the voltage diagram 600E. Thus, during the on phase, the capacitor 530 is charged to a voltage of VR whilst the output voltage Vramp of the ramp circuit 500 is fixed at Vp.

A time T1, an off phase begins as apparent from the state diagram 600A. In response, switches 510a, 510b and 510c open, and switches 520a and 520b are closed. As represented by the voltage diagram 600C between times T1 and T2, the voltage Vbot at the bottom of the capacitor 330 increases to the pedestal voltage Vp due to the switch 510b being closed. This sudden voltage increase at time T1 at the bottom of the capacitor 530 causes a sudden voltage increase at the top of the capacitor 530. Thus, as represented by the voltage diagram 600B at time T1, the voltage Vtop suddenly increases at time T1 by the pedestal voltage Vp from Vr to Vr+Vp. Moving forward from time T1, this switch configuration also causes the top terminal of the capacitor to discharge through a current source 550 that has a current draw I that is equal to VREF divided by a fixed resistance.

As represented by voltage diagram 600B between times T1 and T2, the voltage Vtop at the top of the capacitor 330 reduces at a rate of

$$\frac{{d V}_{RAMP}}{dt}$$

which is proportional to VREF which is proportional to the output voltage VOUT of the constant on-time voltage-to-voltage converter 300. This is because the current discharging current I is equal to VREF/R. Now, the selection of R should be inversely proportional to the switching frequency to ensure stability. Accordingly, as represented by the voltage signal 600D (which is merely the voltage signal 600B minus the voltage signal 600D), the voltage Vcap across the capacitor 330 decreases the rate of

$$\frac{{d V}_{RAMP}}{dt} .$$

In the off state, the output voltage Vramp of the ramp circuit 300 is the same as the voltage Vtop at the top of the capacitor 530 since switch 520A is closed. Thus, the ramp circuit outputs a ramp voltage that declines at a rate of

$$\frac{{d V}_{RAMP}}{dt}$$

which rate is a function of (e.g., proportional to) the output voltage VOUT of the entire constant on-time voltage-to-voltage converter 300.

Between times T2 and T3, there is another on phase as represented by the state diagram 600A. This causes the voltage signals 600B through 600E to assume the same state as they had during the prior on phase between times T0 and T1 for the same reasons described above for the previous on state. Between times T3 and T4, another off phase as represented by the state diagram 600A. This causes the voltage signals 600B through 600E to assume the same state as they had during the prior off phase between times T1 and T2 for the same reasons described above for the previous on state.

The operation of the ramp circuit 500 to achieve the DCM mode while controlling the ramp voltage slope will be described with respect to FIG. 7. FIG. 7 shows several states and signals in which time is represented by horizontal positioning. The state diagram 700A is identical to the state diagram 600A of FIG. 6. The converter is in an on state between times T0 and T1, an off state between times T1 and T2, an on state between times T2 and T3, and an off state between times T3 and T4.

Like the signal diagram 600B, the signal diagram 700B represents the voltage Vtop. However, unlike the signal diagram 600B, the signal diagram 700B shows that the voltage Vtop decreases by VR until the voltage Vtop is clamped to the pedestal voltage Vp, which occurs prior to the transition to the off state. The voltage diagram 700C of the voltage Vbot is identical though to the signal diagram 600C. The voltage diagram 700D is the difference between the voltage diagram 700B and the voltage diagram 700C and thus in the off phase the voltage Vcap is completely discharged (again with the rate

$$\frac{{d V}_{RAMP}}{dt} )$$

until being completely discharged at zero voltage prior to each subsequent on phase. Accordingly, as shown by the voltage diagram the output Vramp of the ramp circuit is zero during the on phase of the converter, but decreases from Vr to zero at a rate of

$$\frac{{d V}_{RAMP}}{dt}$$

during the off phase of the converter.

Thus, the principles described herein describe a constant on-time voltage-to-voltage converter that has a ramp circuit that changes the rate of change of the ramp voltage in order to achieve stability across a wide range of output voltages.

### Literal Support Section

Clause 1. A constant on-time voltage-to-voltage converter, comprising: an alternation circuit configured to alternate control of the constant on-time voltage-to-voltage converter between a constant on-time phase having a constant on-time and a variable off-time phase that has a variable off-time, such that during the constant on-time phase an output terminal of the constant on-time voltage-to-voltage converter is coupled to a first input terminal of the constant on-time voltage-to-voltage converter, and such that during the off-time phase the output terminal of the constant on-time voltage-to-voltage converter is coupled to a second voltage source; and a variable off-time feedback loop coupled between the output terminal and the alternation circuit so as to adjust the variable off-time depending on an output voltage present on the output terminal, the variable off-time feedback loop including a ramp circuit configured to generate a ramp voltage in which a rate of change of the ramp voltage depends on the output voltage present on the output terminal, the variable off-time feedback loop further comprising a comparator that receives the ramp voltage and generates an off-time signal that depends on the rate of change of the ramp voltage generated by the ramp circuit, the comparator coupled to the alternation circuit so as to provide the generated off-time signal to the generation circuit, the alternation circuit further configured to control the variable off-time phase depending on the off-time signal generated by the comparator.
Clause 2. The constant on-time voltage-to-voltage converter according to Clause 1, the alternation circuit comprising a control circuit and a buck converter, wherein the control circuit controls the on-time of the constant on-time voltage-to-voltage converter by controlling an on-time of the buck converter, and the control circuit controls the off-time of the constant on-time voltage-to-voltage converter by controlling an off-time of the buck converter.
Clause 3. The constant on-time voltage-to-voltage converter according to Clause 1, the first input voltage being higher than the second input voltage.
Clause 4. The constant on-time voltage-to-voltage converter according to Clause 1, the second input voltage being ground.
Clause 5. The constant on-time voltage-to-voltage converter according to Clause 1, the alternation circuit further comprising an inductor, the converter configured such that during the constant on-time phase, the output terminal of the constant on-time voltage-to-voltage converter is coupled to the first input terminal of the constant on-time voltage-to-voltage converter via the inductor, and such that during the variable off-time phase, the output terminal of the constant on-time voltage-to-voltage converter is coupled to the second voltage source via the inductor.
Clause 6. The constant on-time voltage-to-voltage converter according to Clause 5, the constant on-time voltage-to-voltage converter further comprising a capacitor connected to the output terminal of the constant on-time voltage-to-voltage converter.
Clause 7. The constant on-time voltage-to-voltage converter according to Clause 6, the ramp circuit being coupled to a first input node of the comparator, the variable off-time feedback loop further comprising a compensator configured to generate a compensated voltage that depends on the output voltage present at the output terminal, the compensator being coupled to a second input node of the comparator, such that the comparator receives the ramp voltage on the first input node and receives the compensated voltage on the second input node.
Clause 8. The constant on-time voltage-to-voltage converter according to Clause 7, the variable off-time feedback loop further comprising a voltage divider, an input node of the ramp circuit being coupled to the output terminal of the constant on-time voltage-to-voltage converter by being coupled to a voltage-divided node of the voltage divider, such that the ramp voltage is dependent on a feedback voltage present on the voltage-divided node.
Clause 9. The constant on-time voltage-to-voltage converter according to Clause 8, the ramp circuit comprising: a ramp capacitor having a first terminal and a second terminal; a first switch connected between a ramp amplitude voltage terminal configured to receive a ramp amplitude voltage, and the first terminal of the ramp capacitor; a second switch connected between the low voltage source and the second terminal of the ramp capacitor; a third switch connected between the first terminal of the ramp capacitor and a ramp output terminal on which the ramp circuit provides the ramp voltage; a fourth switch connected between the second terminal of the ramp capacitor and a ramp pedestal terminal configured to receive a ramp pedestal voltage; a fifth switch connected between the ramp output terminal and the ramp pedestal terminal; an amplifier having a first input node connected to the ramp output terminal, a second input node connected to the ramp pedestal terminal, and an output node connected to the ramp output terminal, such that the ramp voltage on the ramp output terminal is prevented from dropping below the ramp pedestal voltage; and a current source connected to the ramp output terminal, the current source being configured to provide a current that depends on the feedback voltage from the voltage divider.
Clause 10. The constant on-time voltage-to-voltage converter according to Clause 9, the ramp circuit being configured such that during a ramp on-phase, the first switch, the second switch and the fifth switch are closed while the third switch and fourth switch are opened, such that the ramp capacitor is charged to approximately the ramp amplitude voltage, and such that the ramp voltage on the ramp output terminal is clamped to the ramp pedestal voltage; and during a ramp off-phase, the first switch, the second switch, and the fifth switch are opened while the third switch and the fourth switch are closed, such that voltage on the top terminal of the ramp capacitor increases to approximately the ramp amplitude voltage plus the ramp pedestal voltage, thereby also causing the ramp voltage on the ramp output terminal to initially increase to be approximately equal to the ramp amplitude voltage plus the ramp pedestal voltage, the ramp voltage on the ramp output terminal linearly decreasing after the initial increase of the ramp voltage at the beginning of the ramp off-phase, the linear decrease of the ramp voltage depending on the output voltage on the output terminal of the constant on-time voltage-to-voltage converter.
Clause 11. The constant on-time voltage-to-voltage converter according to Clause 10, the linear decrease of the ramp voltage being approximately equal to a current pulled by the current source connected to the ramp output terminal divided by the capacitance of the ramp capacitor.
Clause 12. The constant-on-time voltage-to-voltage converter according to Clause 10, the ramp pedestal voltage being approximately equal to the feedback voltage plus a common-mode voltage.
Clause 13. The constant on-time voltage-to-voltage converter according to Clause 1, the alternation circuit further being configured to control the constant on-time phase in response to a signal from a timer.
Clause 14. The constant on-time voltage-to-voltage converter according to Clause 1, the converter being configured to operate in continuous conduction mode.
Clause 15. The constant on-time voltage-to-voltage converter according to Clause 14, the converter being configured to operate in also in discontinuous conduction mode.
Clause 16. The constant on-time voltage-to-voltage converter according to Clause 1, the converter being configured to operate in discontinuous conduction mode.

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present disclosure may be embodied in other specific forms without departing from its essential characteristics. The described embodiments are to be considered in all respects only as illustrative and not restrictive. All changes which come within the meaning and range of equivalency of the claims are to be embraced within their scope.

When introducing elements in the appended claims, the articles “a,” “an,” “the,” and “said” are intended to mean there are one or more of the elements. The terms “comprising,” “including,” and “having” are intended to be inclusive and mean that there may be additional elements other than the listed elements.

What is claimed is:

1. A constant on-time voltage-to-voltage converter, comprising:
an alternation circuit configured to alternate control of the constant on-time voltage-to-voltage converter between a constant on-time phase having a constant on-time and a variable off-time phase that has a variable off-time, such that during the constant on-time phase an output terminal of the constant on-time voltage-to-voltage converter is coupled to a first input terminal of the constant on-time voltage-to-voltage converter, and such that during the off-time phase the output terminal of the constant on-time voltage-to-voltage converter is coupled to a second voltage source; and
a variable off-time feedback loop coupled between the output terminal and the alternation circuit so as to adjust the variable off-time depending on an output voltage present on the output terminal, the variable off-time feedback loop including a ramp circuit configured to generate a ramp voltage in which a rate of change of the ramp voltage depends on the output voltage present on the output terminal, the variable off-time feedback loop further comprising a comparator that receives the ramp voltage and generates an off-time signal that depends on the rate of change of the ramp voltage generated by the ramp circuit, the comparator coupled to the alternation circuit so as to provide the generated off-time signal to the generation circuit, the alternation circuit further configured to control the variable off-time phase depending on the off-time signal generated by the comparator.

2. The constant on-time voltage-to-voltage converter according to claim 1, the alternation circuit comprising a control circuit and a buck converter, wherein the control circuit controls the on-time of the constant on-time voltage-to-voltage converter by controlling an on-time of the buck converter, and the control circuit controls the off-time of the constant on-time voltage-to-voltage converter by controlling an off-time of the buck converter.

3. The constant on-time voltage-to-voltage converter according to claim 1, the first input voltage being higher than the second input voltage.

4. The constant on-time voltage-to-voltage converter according to claim 1, the second input voltage being ground.

5. The constant on-time voltage-to-voltage converter according to claim 1, the alternation circuit further comprising an inductor, the converter configured such that during the constant on-time phase, the output terminal of the constant on-time voltage-to-voltage converter is coupled to the first input terminal of the constant on-time voltage-to-voltage converter via the inductor, and such that during the variable off-time phase, the output terminal of the constant on-time voltage-to-voltage converter is coupled to the second voltage source via the inductor.

6. The constant on-time voltage-to-voltage converter according to claim 5, the constant on-time voltage-to-voltage converter further comprising a capacitor connected to the output terminal of the constant on-time voltage-to-voltage converter.

7. The constant on-time voltage-to-voltage converter according to claim 6, the ramp circuit being coupled to a first input node of the comparator, the variable off-time feedback loop further comprising a compensator configured to generate a compensated voltage that depends on the output voltage present at the output terminal, the compensator being coupled to a second input node of the comparator, such that the comparator receives the ramp voltage on the first input node and receives the compensated voltage on the second input node.

8. The constant on-time voltage-to-voltage converter according to claim 7, the variable off-time feedback loop further comprising a voltage divider, an input node of the ramp circuit being coupled to the output terminal of the constant on-time voltage-to-voltage converter by being coupled to a voltage-divided node of the voltage divider, such that the ramp voltage is dependent on a feedback voltage present on the voltage-divided node.

9. The constant on-time voltage-to-voltage converter according to claim 8, the ramp circuit comprising:
a ramp capacitor having a first terminal and a second terminal;
a first switch connected between a ramp amplitude voltage terminal configured to receive a ramp amplitude voltage, and the first terminal of the ramp capacitor;
a second switch connected between a low voltage source and the second terminal of the ramp capacitor;
a third switch connected between the first terminal of the ramp capacitor and a ramp output terminal on which the ramp circuit provides the ramp voltage;
a fourth switch connected between the second terminal of the ramp capacitor and a ramp pedestal terminal configured to receive a ramp pedestal voltage;
a fifth switch connected between the ramp output terminal and the ramp pedestal terminal;
an amplifier having a first input node connected to the ramp output terminal, a second input node connected to the ramp pedestal terminal, and an output node connected to the ramp output terminal, such that the ramp voltage on the ramp output terminal is prevented from dropping below the ramp pedestal voltage; and
a current source connected to the ramp output terminal, the current source being configured to provide a current that depends on the feedback voltage from the voltage divider.

10. The constant on-time voltage-to-voltage converter according to claim 9, the ramp circuit being configured such that:
during a ramp on-phase, the first switch, the second switch and the fifth switch are closed while the third switch and fourth switch are opened, such that the ramp capacitor is charged to approximately the ramp amplitude voltage, and such that the ramp voltage on the ramp output terminal is clamped to the ramp pedestal voltage; and
during a ramp off-phase, the first switch, the second switch, and the fifth switch are opened while the third switch and the fourth switch are closed, such that voltage on the top terminal of the ramp capacitor increases to approximately the ramp amplitude voltage plus the ramp pedestal voltage, thereby also causing the ramp voltage on the ramp output terminal to initially increase to be approximately equal to the ramp amplitude voltage plus the ramp pedestal voltage, the ramp voltage on the ramp output terminal linearly decreasing after the initial increase of the ramp voltage at the beginning of the ramp off-phase, the linear decrease of the ramp voltage depending on the output voltage on the output terminal of the constant on-time voltage-to-voltage converter.

11. The constant on-time voltage-to-voltage converter according to claim 10, the linear decrease of the ramp voltage being approximately equal to a current pulled by the current source connected to the ramp output terminal divided by the capacitance of the ramp capacitor.

12. The constant on-time voltage-to-voltage converter according to claim 10, the ramp pedestal voltage being approximately equal to the feedback voltage plus a common-mode voltage.

13. The constant on-time voltage-to-voltage converter according to claim 1, the alternation circuit further being configured to control the constant on-time phase in response to a signal from a timer.

14. The constant on-time voltage-to-voltage converter according to claim 1, the converter being configured to operate in continuous conduction mode.

15. The constant on-time voltage-to-voltage converter according to claim 14, the converter being configured to operate in also in discontinuous conduction mode.

16. The constant on-time voltage-to-voltage converter according to claim 1, the converter being configured to operate in discontinuous conduction mode.
